(19) United States
(12) Patent Application Publication
(10) Pub. No.: US 2026/0301325 A1
(43) Pub. Date: Oct. 1, 2026

(54) CHARACTER CONTROL DEVICE, TERMINAL DEVICE, AND VIRTUAL SPACE PROVIDING SYSTEM

(71) Applicant: NTT DOCOMO, INC., Tokyo (JP)

(72) Inventors: Jun SAKANO, Tokyo (JP); Kenichirou KAWAMOTO, Tokyo (JP); Yuuki YAMADA, Tokyo (JP); Yuuta HAYASHI, Tokyo (JP); Yoshihiro FUJIEDA, Tokyo (JP)

(73) Assignee: NTT DOCOMO, INC., Tokyo (JP)

(21) Appl. No.: 19/489,085

(22) PCT Filed: Aug. 6, 2024
(86) PCT No.: PCT/JP2024/028110

§ 371 Date: Dec. 1, 2025

(30) Foreign Application Priority Data
Aug. 16, 2023 (JP) 2023-132641

(51) Int. Cl. G06T 19/00

(52) U.S. Cl. CPC G06T 19/00

(57) ABSTRACT

The objective of the present invention is to provide a character control device capable of causing a computer character to perform actions appropriate for a user.

In a dialogue generation server 100 according to the present disclosure, an action decision unit 102 decides an action of a computer character on the basis of user information about a user and a response time (a response estimation time) required for a response of a predetermined action for a computer character if the predetermined action from a user character operated by the user in a virtual space provided to a user terminal 200 is received from the user terminal 200. A character control unit 103 causes the decided action of the computer character to be displayed on the user terminal 200.

### TECHNICAL FIELD

The present invention relates to a character control device, a terminal device, and a virtual space providing system for controlling a character in a virtual space.

### BACKGROUND ART

As described in Patent Literature 1, an NPC object is presented in a virtual space and the NPC object's action is presented in the virtual space in response to an action from a user.

### CITATION LIST

### Patent Literature

[Patent Literature 1] Japanese Unexamined Patent Publication No. 2019-106220

### SUMMARY OF INVENTION

### Technical Problem

In the technology described in Patent Literature 1, there may be a delay in an action of a non-player character (NPC) object (hereinafter referred to as a computer character) according to an action of a user. In this case, the user is unable to smoothly communicate with the computer character. For example, while the user is conversing with a computer character in the virtual space, the computer character needs to think about a response to be made in its dialogue with the user. The waiting time for the user caused by this thinking creates a stressful problem for the user. In addition, it may be desirable to cause the computer character to perform actions that are appropriate for the user, in accordance with a situation in which the user is placed.

Therefore, an objective of the present invention is to provide a character control device, a terminal device, and a virtual space providing system that can cause a computer character to perform actions appropriate for a user.

### Solution to Problem

According to the present invention, there is provided a character control device comprising: an action decision unit configured to decide an action of a computer character on the basis of user information about a user and a response estimation time required for a response of a predetermined action for a computer character if the predetermined action is received from a user character operated by the user in a virtual space; and a character control unit configured to present the decided action of the computer character to the user.

### Advantageous Effects of Invention

According to the present invention, it is possible to cause a computer character to perform actions appropriate for a user.

### BRIEF DESCRIPTION OF DRAWINGS

FIG. 1 is a diagram showing a system configuration including a dialogue generation server 100, which is a character control device of the present disclosure.

FIG. 2 is a schematic diagram of a virtual space in the present disclosure.

FIG. 3 is a block diagram showing a functional configuration of the dialogue generation server 100 and a user terminal 200 of the present disclosure.

FIG. 4 is a diagram showing a processing sequence in the dialogue generation server 100 and the user terminal 200 of the present disclosure.

FIG. 5 is a flowchart showing a detailed process of processing steps S103 and S104.

FIG. 6 is a flowchart showing detailed processes of action decision and control of a computer character of processing step S208.

FIG. 7 is a diagram showing a dialogue between a user character C2 and a computer character C1 in a virtual space of the present disclosure.

FIG. 8 is a diagram showing an example of a hardware configuration of the dialogue generation server 100 according to an embodiment of the present disclosure.

### DESCRIPTION OF EMBODIMENTS

Embodiments of the present disclosure will be described with reference to the accompanying drawings. If possible, the same reference signs are used for the same parts, and redundant descriptions will be omitted.

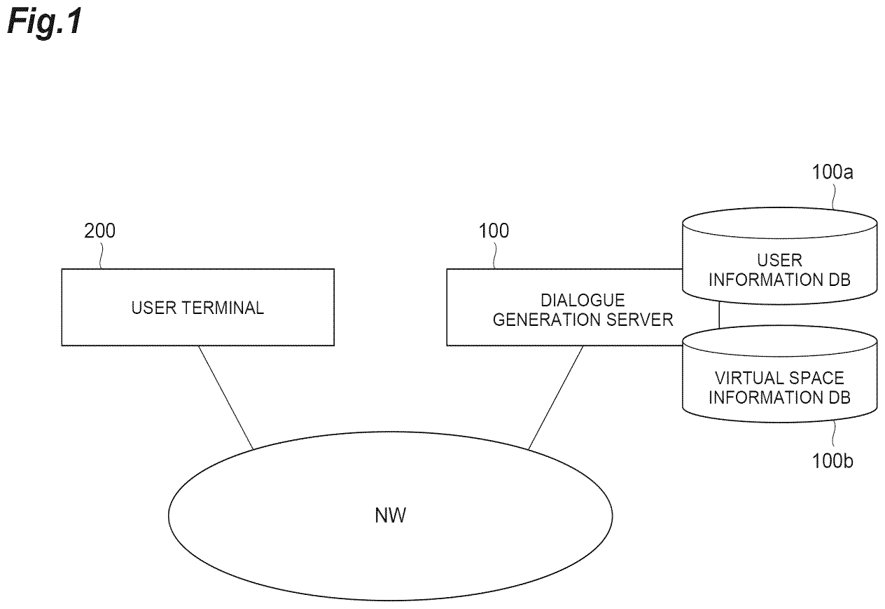

FIG. 1 is a diagram showing a system configuration including a dialogue generation server 100, which is a character control device of the present disclosure. As shown in FIG. 1, the dialogue generation server 100 includes a user information DB 100a and a virtual space information DB 100b. The dialogue generation server 100 generates a virtual space with reference to the virtual space information DB 100b and transmits the generated virtual space to the user terminal 200.

The user terminal 200, for example, is a terminal device such as a smartphone or VR goggles, and is a terminal operated by the user. When the user terminal 200 receives the provision of a virtual space from the dialogue generation server 100, it displays a user character and a computer character (so-called NPC) in the virtual space. The user character and the computer character are characters generated in the dialogue generation server 100.

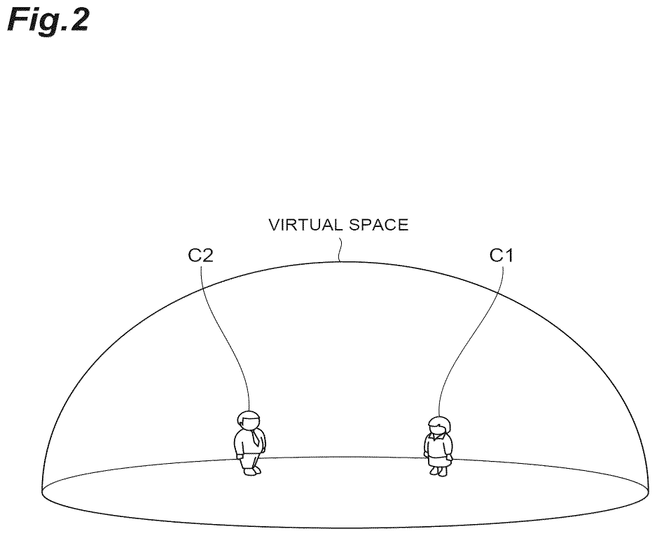

FIG. 2 is a schematic diagram of a virtual space in the present disclosure. As shown in FIG. 2, a computer character C1 and a computer character C2 are arranged in the virtual space. Although there are one computer character C1 and one user character C2 as the premise of the control in the present disclosure, there are a plurality of computer characters and a plurality of user characters in the virtual space.

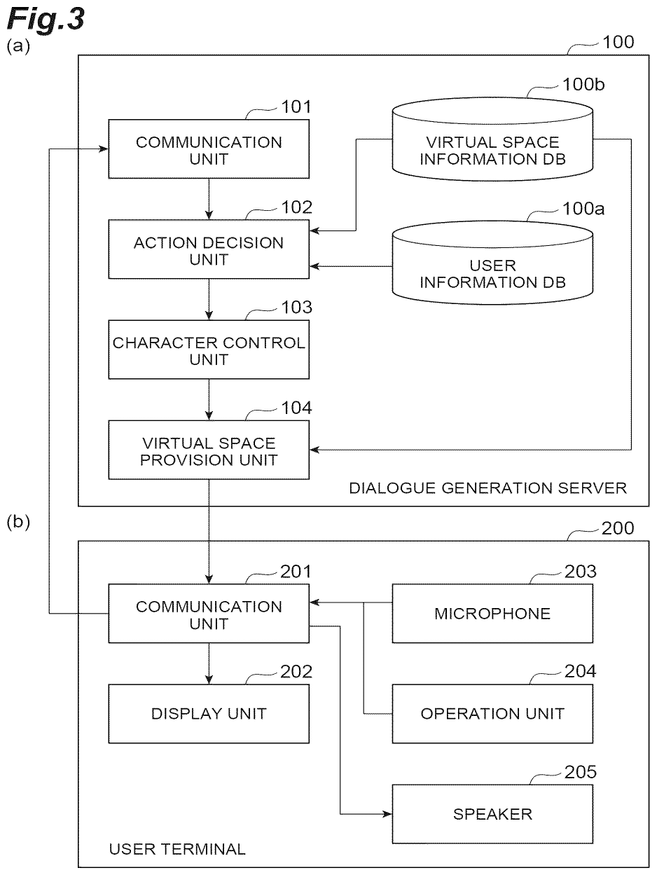

FIG. 3 is a block diagram showing a functional configuration of the dialogue generation server 100 and the user terminal 200 of the present disclosure. As shown in FIG. 3, FIG. 3(a) is a block diagram showing a functional configuration of the dialogue generation server 100. The dialogue generation server 100 is configured to include a communication unit 101, an action decision unit 102, a character control unit 103, a virtual space provision unit 104, a user information DB 100a, and a virtual space information DB 100b.

The communication unit 101 is a part that communicates with the user terminal 200. The communication unit 101 receives information (e.g., a vocal sound) about the action of the user character that is operated by the user from the user terminal 200.

The action decision unit 102 is a part that decides an action of the computer character C1 on the basis of the information about the action and the user information. The action decision unit 102 estimates a response time on the basis of the information about the action before the action decision. For example, the action decision unit 102 calculates a response time of a calculation process for dialogue generation obtained by preliminary verification and designates the calculated response time as the response time. For example, for each of a plurality of dialogues, the time for the computer character to respond to the dialogue is calculated by experiments or the like and the response time is calculated for each dialogue. The response time calculation method is not limited to the above, and other known methods may be used.

Moreover, the action decision unit 102 calculates the response time on the basis of a network congestion level obtained by a network bandwidth between the server and the user terminal. Specifically, the action decision unit 102 estimates the response time according to the network congestion level by using packet-based methods (e.g., transmitting a ping and measuring the response time).

The above-described response time calculation is not limited to the above-described two examples (delay in deciding dialogue content and NW (network) delay), and other events requiring the response time may also be considered. Moreover, the response time is decided on the basis of the longer time among the estimated time to decide the dialogue content, the NW delay time, and the delay time due to other events. Although the estimated time to decide the dialogue content and the response time based on the delay time of the NW are used for convenience of description in the processing flow to be described below, other delay times may naturally be considered.

Also, the action decision unit 102 decides an action (an intervention process) of the computer character C1 on the basis of the response time. For example, the action decision unit 102 performs the intervention process with an appropriate user stress relief countermeasure based on the response time. Details of a relationship between the intervention process and the response time and the user information will be described below.

The character control unit 103 is a part that controls the computer character C1 to perform an action decided by the action decision unit 102.

The virtual space provision unit 104 is a part that provides (transmits) the virtual space to the user terminal 200. This virtual space includes a user character C2 and a computer character C1, and each computer character C1 is controlled to operate in a decided action. The user character C2 is controlled to perform an action in accordance with an operation from the user terminal 200.

The virtual space information DB 100b is a part that stores information for constructing the virtual space provided to the user terminal 200. This virtual space information DB 100b stores information about the virtual space, a specific area located in the virtual space, and a computer character acting in the specific area as information for constructing the virtual space. A specific area is, for example, an area where the user character can perform an action such as shopping in the virtual space, such as a store or a facility. Naturally, the system is not limited to these, and may store other information for constructing facilities present in the real world and the like in the virtual space.

The user information DB 100a is a part that stores user information about the user of the user terminal 200. The user information about the user is any information related to the user, including, for example, user characteristics. In addition, it includes information other than user characteristics, such as the user's location and the time period of day. In the present disclosure, the user characteristics include information indicating an acceptance level for the action (intervention countermeasure) of the computer character, and neurotic tendencies, extroversion, openness, cooperativeness, sincerity, and the like are considered.

In addition, the user information may include at least one item of information about the user, such as a location, a time period of day, a display aspect of the user character (a character of the speaking user) and a state of the user operating the user character C2.

FIG. 3(b) is a block diagram showing a functional configuration of the user terminal 200. As shown in FIG. 3(b), the user terminal 200 is configured to include a communication unit 201, a display unit 202, a microphone 203, an operation unit 204, and a speaker 205. This user terminal 200, for example, may take a VR goggle-type configuration, but may also be in other forms.

The communication unit 201 is a part that receives information about the virtual space from the dialogue generation server 100 or transmits user operation information to the dialogue generation server 100.

The display unit 202 is a part that displays the virtual space, the computer character C1, and the user character C2 contained in the virtual space, and the like.

The microphone 203 is a part that receives the user's vocal sound for the user character C2 to speak to the computer character C1 in the virtual space.

The operation unit 204 is a part that receives an operation of the user character C2 in the virtual space. In addition, a keyboard or the like may be provided for text-based speech through chatting or the like.

The speaker 205 is a part that outputs a vocal sound from the computer character C1 and the like in the virtual space.

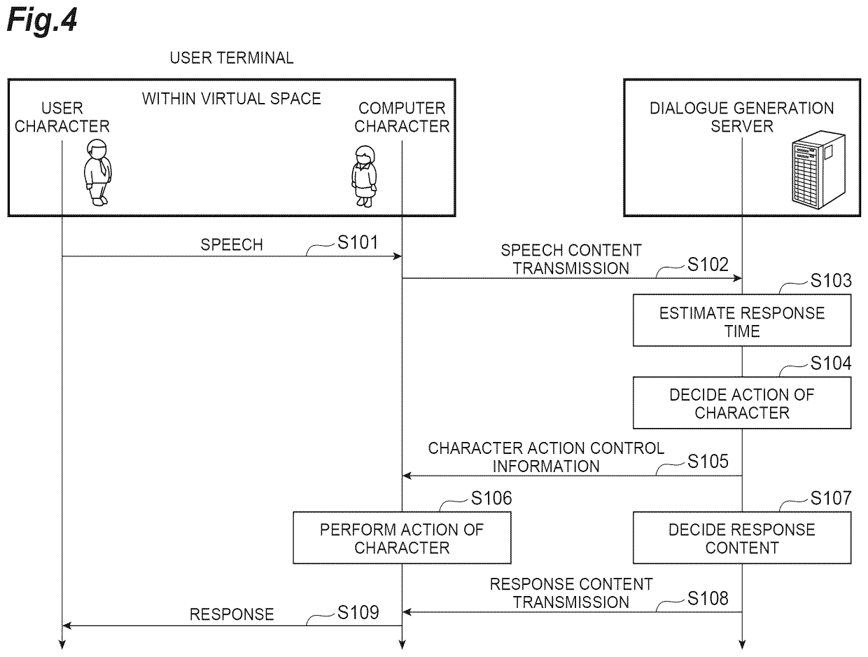

FIG. 4 is a diagram showing a processing sequence in the dialogue generation server 100 and the user terminal 200 of the present disclosure.

As shown in FIG. 4, the user (the user character C2) speaks to the computer character C1 in the virtual space displayed on the user terminal 200 (S101). Also, vocal sound data is transmitted from the user terminal 200 to the dialogue generation server 100 (S102).

In the dialogue generation server 100, the action decision unit 102 estimates a response time on the basis of a network congestion level and a time period required to make an appropriate response for speech content (S103). Also, the action decision unit 102 decides the character's action on the basis of the response time (S104).

The character control unit 103 transmits character action control information indicating an action of the character to the user terminal 200 via the virtual space provision unit 104 (S105). In the user terminal 200, the computer character C1 performs an action according to the character action control information (S106). As mentioned above, depending on the response time, it may make the user wait and cause stress. Therefore, the actions here shall be simple actions (e.g., back-channeling and the like), but, of course, they are not limited to such actions.

Subsequently, in the dialogue generation server 100, the action decision unit 102 decides response content according to speech content of the user character C2 (S107), and the virtual space provision unit 104 transmits the response content to the user terminal 200 (S108). Also, in the user terminal 200, the computer character C1 responds to the user character C2 according to the response content (S109).

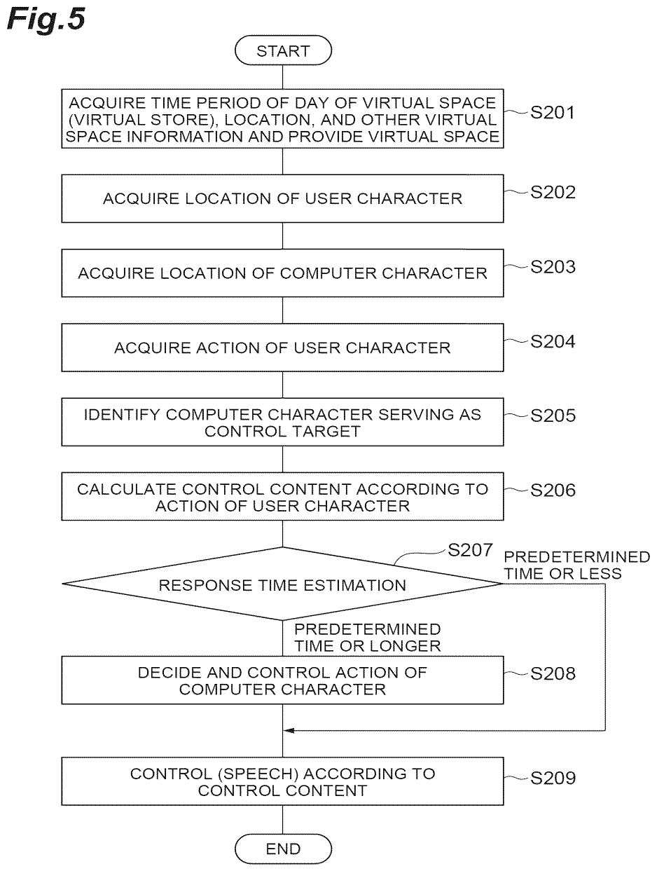

FIG. 5 is a flowchart showing a process of providing the virtual space and a detailed process of processing steps S103 and S104 in FIG. 4.

In the dialogue generation server 100, the virtual space provision unit 104 acquires a time period of day, a location, and other virtual space information of the virtual space (including virtual stores) from the virtual space information DB 100b and provides the virtual space to the user terminal 200 (S201).

The communication unit 101 acquires location information of the user character from the user terminal 200 (S202). Moreover, the virtual space provision unit 104 acquires location information of the computer character (S203). In this way, the virtual space provision unit 104 represents the user character and the computer character in the virtual space and provides the user character and the computer character to the user terminal 200.

Also, the communication unit 101 acquires the user character's action from the user terminal 200 (S204). The action decision unit 102 identifies a computer character serving as a control target on the basis of the action of the user character (including dialogue content in this case) (S205). For example, when the user character speaks to the computer character, the computer character is identified on the basis of the user character's location and speech content. The vocal content is content of the user character (user) speaking to the computer character. In accordance with the vocal content, for example, it is possible to determine whether the user has spoken to a shopkeeper (a computer character) in the virtual space or to a passerby (a computer character).

Also, the action decision unit 102 calculates control content for the computer character's action according to the user character's action (S206) and estimates a response time (response estimation time) (S207). When the response time is longer than or equal to a predetermined time, the action decision unit 102 decides and controls the computer character's action according to the time (S208). For example, the action decision unit 102 decides a predetermined gesture and performs control for causing the computer character to operate the gesture so that stress is not given to the user waiting for the response time until the control content is decided.

Subsequently, when the control content is decided, the action decision unit 102 performs a control process for causing the computer character to perform an action according to the control content (S209).

In FIG. 5, the actions of the user and computer characters include actions such as speech and gestures.

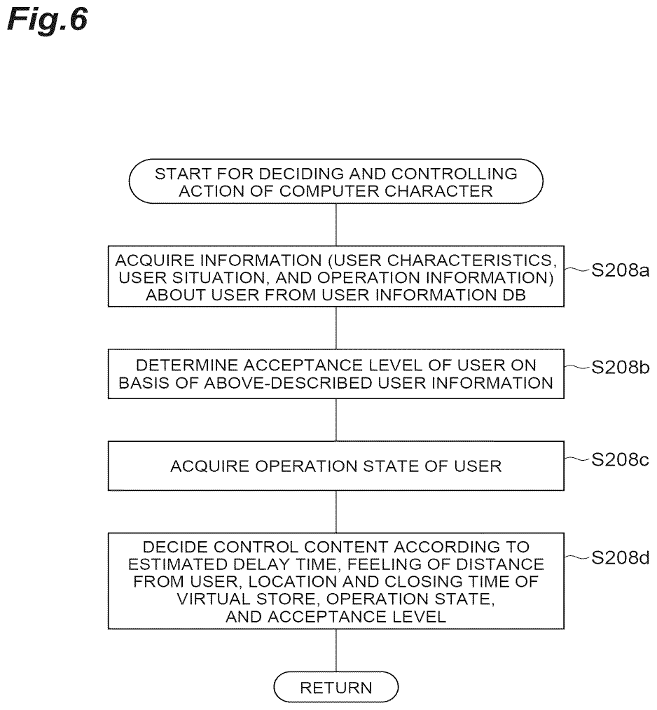

FIG. 6 is a flowchart showing detailed processes of action decision and control of the computer character in processing step S208. The action decision unit 102 acquires user information (user characteristics, user states, and operation information) about the user of the user terminal 200 from the user information DB 100a (S208a). The action decision unit 102 determines the user's acceptance level on the basis of the above-described user information (S208b). For example, the user's acceptance level is a value that indicates how much time the user can accept for the waiting time, and the larger the value, the higher the user's acceptance level for the waiting time. In addition, the value may be controlled to increase or decrease depending on the time period of day, and may be a value indicating that mornings are rushed (low acceptance level) and afternoons are not rushed (high acceptance level).

Also, the action decision unit 102 acquires the user's operation state (S208c). The action decision unit 102 may acquire the operation state, such as a speaker volume on the user side, and the action decision unit 102 may acquire the user operation or setting in which the user character is feeling embarrassed or fidgeting.

The action decision unit 102 further acquires information about a feeling of a distance from the user and a location and closing time of the virtual store, and decides control content according to at least one of the distance from the user, the location and closing time of the virtual store, the operation state, and the acceptance level in addition to the response time (S208d). The feeling of the distance from the user is information based on the locations of the user and computer characters, and is a virtual distance in the virtual space. The location and closing time of the virtual store are information acquired from the virtual space information DB 100b. In addition to these information items, the virtual space information DB 100b may also store a congestion situation in the virtual space (or virtual store).

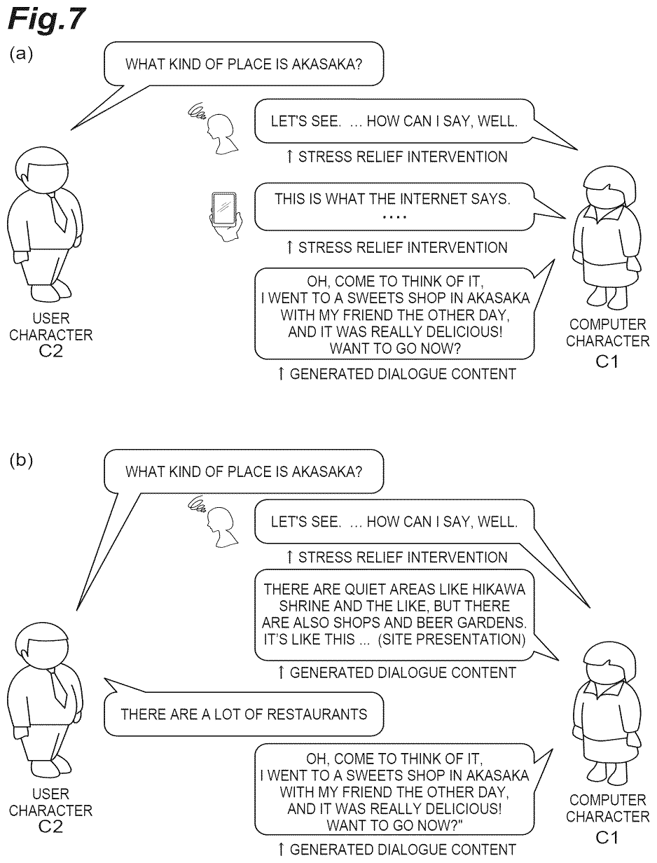

FIG. 7 shows a dialogue between the user character C2 and the computer character C1 in the virtual space to which the technology of the present disclosure is applied. In FIG. 7(a), the user character C2 speaks to the computer character C1, “What kind of place is Akasaka?”

The computer character C1 responds by saying, “Let's see. . . . How can I say, well.” Here, the action decision unit 102 calculates the response time required to respond to the dialogue content of the user character C2 and determines that the response time is long (a predetermined time or longer), so the computer character C1 responds with the above-described content for the time being. Also, the action decision unit 102 further derives the response content, “This is what the Internet says. (site presentation),” and causes the computer character C1 to take action. Here, a simple Internet site is presented. These actions are the stress relief intervention process for the user. In addition, if the response time of the action decision unit 102 is short (within the predetermined time), the computer character C1 may be allowed to respond only with the content of “Let's see. . . . How can I say, well.”

FIG. 7(b) is its specific example. The action decision unit 102 responds by generating the content “There are quiet areas like the Hikawa Shrine and the like . . . ” after the stress relief intervention. Subsequently, when user character C2 connects the dialogue with “There are lots of restaurants”, the action decision unit 102 calculates the response time, determines that the response time is short here, and generates the response content, “Oh, come to think of it, I went . . . with a friend the other day,” and responds.

In this way, stress relief intervention for the user can be performed on the basis of the response time in the dialogue between the user character C2 and the computer character C1.

Next, a switching pattern of the action according to the response time of the present disclosure will be described. FIG. 7 described above is an example of an intervention process, and various other intervention processes are possible. When the response time (delay time) is short, the action decision unit 102 causes the computer character C1 to perform a predetermined gesture. For example, the action decision unit 102 may cause the computer character C1 to make a physical movement as if it is contemplating. Thereby, it is possible to reduce stress on the user's response time (delay time) because at least some action is performed by the computer character.

Moreover, when the response time is short, the action decision unit 102 may perform an intervention process that does not produce a silent time and does not make the response time (delay time) felt by using words such as “Let's see,” “How can I say, well,” as connecting words.

Moreover, when the response time is short, the action decision unit 102 may repeat a parroted response, e.g., “(the content of the question) means . . . ” or the like. Thereby, it is possible to perform an intervention process that does not make the response time felt.

Moreover, when the response time (delay time) is long, the action decision unit 102 may cause the related site or video view to be displayed and perform the intervention process that does not make the response time (delay time) felt depending on a viewing time.

Furthermore, in addition to considering the above-described response time, the action decision unit 102 can decide the action of the computer character C1 on the basis of the user information.

For example, the action decision unit 102 decides a gesture type on the basis of a distance between the computer character C1 and the user character C2 on the basis of a location indicated in the user information (in this case, the user information includes location information). The gesture type is a predetermined gesture, but may also be a large or small gesture, such as a large gesture or a small gesture. Moreover, when the location indicated in the user information is in a predetermined store (crowded store), the action decision unit 102 may decide the gesture based on the store type (the congestion level is high or low). The store type and congestion level may be stored in the virtual space information DB 100b.

In addition, the action decision unit 102 may determine the gesture type on the basis of information about whether the store is crowded as well as whether the user is in the predetermined store, depending on the congestion level. Information about whether or not the store is crowded may be acquired or measured from the virtual space information DB 100b or from other devices. For the measurement method, for example, the number of user characters displayed in the store may be measured, and it may be determined that the store is crowded if there are a predetermined number or more of user characters. Moreover, when a predetermined number of user characters are located within a certain distance of the user's user character, the system may determine that the user characters are crowded and reduce the number of gestures of the computer character that the user is speaking to. Moreover, in the case of a store in the virtual space merged with the real world, the congestion degree of the actual store may be reflected. Other conventional and common methods may also be used.

Moreover, when the user information indicates a time period of day, the action decision unit 102 may decide a quiet gesture in the case of a predetermined time period of day, such as a time period of day when the user is sleeping. Moreover, when the user is located in the predetermined store, the action decision unit 102 may decide a gesture that is a little faster and creates a sense of haste during the busy hours before the store closes.

Moreover, when the user information includes the display aspect of the user character (speaker user), the action decision unit 102 decides the gesture type according to the display aspect. For example, when the user character of the speaker user is fidgeting, the action decision unit 102 determines a gesture that makes the user character speak a little faster and gives the appearance of being in a hurry. Moreover, when the speaker user is feeling embarrassed, a whisper or small gesture decides the speaking action.

Moreover, when the user information includes the state of the user operating the user character, the action decision unit 102 decides the gesture to intervene at normal speed when the conversation is conducted by text and to intervene quickly when the conversation is conducted by a vocal sound. Moreover, when the speaker is turned off (or the volume is set to 0 or low) in a setting process of the user terminal 200, the computer character may act as if it can be understood by gestures instead of a vocal sound.

The above-described user information may be set in the user terminal 200 and the user's user character may act in accordance with the setting process or act according to the operation of the user. Moreover, the actions of the user character may also be automatically controlled actions on the basis of information about the computer character. Information about the computer character is attributes such as a gender and age of the computer character. When the user's user character faces the computer character, the automated action is assumed regardless of the operation of the user on the basis of this information. For example, when the computer character is set up with the attribute that it is a celebrity in the virtual space, the user's user character may take an embarrassing action in accordance with the attribute. This action is assumed to be real-world.

Next, the operation and effects of the dialogue generation server 100 and the user terminal 200 of the present disclosure will be described. Although the dialogue generation server 100 functions as a character control device, this character control device need not be a server. The terminal device may function as the character control device. In this case, the terminal device needs to have a function of generating a virtual space and provide the generated virtual space to the user.

In the dialogue generation server 100 of the present disclosure, the action decision unit 102 decides an action of a computer character on the basis of user information about a user and a response time (a response estimation time) required for a response of a predetermined action for a computer character if the predetermined action from a user character operated by the user in a virtual space provided to the user terminal 200 is received from the user terminal 200. The character control unit 103 causes the decided action of the computer character to be displayed on the user terminal 200.

According to this configuration, the computer character can perform actions decided in accordance with the user information and the response time and the stress on the user due to the waiting time for the response time can be reduced.

Moreover, according to the present disclosure, more appropriate computer character actions can be decided by considering not only the response time but also the user information.

For example, the user information may include information about the user's acceptance level for the computer character's response time (response estimation time).

The user waits for the computer character's action (dialogue) until the response time has elapsed, and the acceptance level varies with the user's personality. In the present disclosure, for example, the action of the computer character can change with a case where the user's acceptance level for the waiting time is large or small.

Moreover, the user information may include information about locations of the user character and the computer character in the virtual space.

Moreover, the information about the locations may indicate a specific area in the virtual space where the user and computer characters are located. The specific area is, for example, a store in the virtual space. A computer character is arranged in a store in the virtual space, and the user (user character) may perform actions (talk) for the computer character. In accordance with the situation of the specific area (such as a congestion situation), the computer character may perform an appropriate action, which may be preferable for the user.

Moreover, the user information may include information about the time period of day when the action has been received from the user character. A process for causing the computer character to perform the appropriate action depending on the time period of day may contribute to reducing the stress on the user.

Moreover, the time period of day may be related to the state of the specific area in the virtual space where the user character is located. A process for assuming a store as a specific area and causing the computer character to perform appropriate actions depending on the closing time of the store may contribute to reducing the stress on the user.

Moreover, the user information may include information about the display aspect of the user character. For example, a user character may be fidgeting or feeling embarrassed in response to user operations or character settings, and the computer character's action may be decided in accordance with such display aspects. Thereby, it is possible to perform appropriate actions according to the user's display aspect.

Moreover, the user information may be the operation state of the user character by the user. For example, as an operation state, the conversation is conducted by text or voice, and the action of the computer character can be decided in accordance with such a state. Thereby, it is possible to perform appropriate actions according to the user's operation state.

The user terminal 200 of the present disclosure includes the display unit 202 configured to display a virtual space including a user character that is operated by the user and a computer character that is controlled by the computer.

This display unit 202 performs a display process according to an action of the computer character decided on the basis of user information about the user and a response time required for a response of the predetermined action if a predetermined action for the computer character is performed from the user character in the virtual space.

Moreover, the virtual space providing system of the present disclosure is a virtual space providing system that includes the user terminal 200 that is operated by a user and a dialogue generation server 100 that provides a virtual space to the user terminal 200.

As described above, the dialogue generation server 100 includes the action decision unit 102 configured to decide an action of a computer character on the basis of user information about a user and a response time required for a response of a predetermined action for a computer character if the predetermined action is received from a user character operated by the user in a virtual space and the character control unit 103 configured to cause the decided action of the computer character to be displayed on the user terminal.

Moreover, the user terminal 200 includes the display unit 202 configured to display the virtual space including the user character that is operated by the user and the computer character that is controlled by the computer.

The dialogue generation server 100, the user terminal 200, and the character control system, which function as a character control apparatus according to the present invention, are configured as follows.
[1] A character control device comprising:
an action decision unit configured to decide an action of a computer character on the basis of user information about a user and a response estimation time required for a response of a predetermined action for the computer character if the predetermined action is received from a user character operated by the user in a virtual space; and
a character control unit configured to present the decided action of the computer character to the user.
[2] The character control device according to [1], wherein the user information is information about the user's acceptance level for a response estimation time of the computer character.
[3] The character control device according to [1] or [2], wherein the user information is information about locations of the user character and the computer character in the virtual space,
[4] The character control device according to [3], wherein the information about the locations indicates a specific area in the virtual space where the user character and the computer character are located.
[5] The character control device according to any one of [1] to [4], wherein the user information is information about a time period of day during which the action has been received from the user character.
[6] The character control device according to [5], wherein the time period of day is related to a state of the specific area in the virtual space where the user character is located.
[7] The character control device according to any one of [1] to [6], wherein the user information is information about a display aspect of the user character.
[8] The character control device according to any one of [1] to [7], wherein the user information is an operation state of the user character by the user.
[9] A terminal device comprising:
a display unit configured to display a virtual space including a user character that is operated by a user and a computer character that is controlled by a computer,
wherein the display unit performs a display process according to an action of the computer character decided on the basis of user information about the user and a response estimation time required for a response of a predetermined action for the computer character if the predetermined action is performed from the user character in the virtual space.
[Claim 10] A virtual space providing system that includes a terminal device that is operated by a user and a server device that provides a virtual space to the terminal device,
wherein the server device includes:
an action decision unit configured to decide an action of a computer character on the basis of user information about a user and a response estimation time required for a response of a predetermined action for the computer character if the predetermined action is received from a user character operated by the user in the virtual space; and
   a character control unit configured to cause the decided action of the computer character to be displayed on a user terminal, and
wherein the terminal device includes
a display unit configured to display the virtual space including the user character that is operated by the user and the computer character that is controlled by a computer.

The block diagram used for the description of the above embodiments shows blocks of functions. Those functional blocks (component parts) are implemented by any combination of at least one of hardware and software. Further, a means of implementing each functional block is not particularly limited. Specifically, each functional block may be implemented by one physically or logically combined device or may be implemented by two or more physically or logically separated devices that are directly or indirectly connected (e.g., by using wired or wireless connection etc.). The functional blocks may be implemented by combining software with the above-described one device or the above-described plurality of devices.

The functions include determining, deciding, judging, calculating, computing, processing, deriving, investigating, looking up/searching/inquiring, ascertaining, receiving, transmitting, outputting, accessing, resolving, selecting, choosing, establishing, comparing, assuming, expecting, considering, broadcasting, notifying, communicating, forwarding, configuring, reconfiguring, allocating/mapping, assigning and the like, though not limited thereto. For example, the functional block (component part) that implements the function of transmitting is referred to as a transmitting unit or a transmitter. In any case, a means of implementation is not particularly limited as described above.

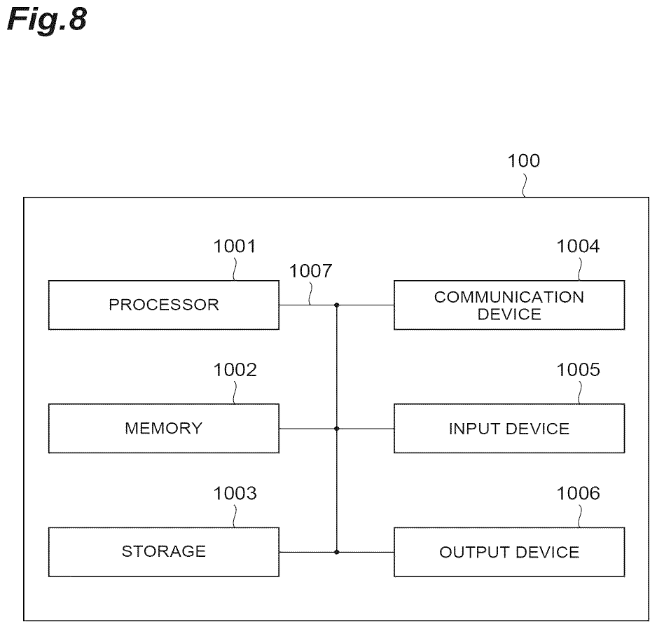

For example, the dialogue generation server 100 and the like according to one embodiment of the present disclosure may function as a computer that performs processing of a dialogue generation method according to the present disclosure. FIG. 8 is a view showing an example of the hardware configuration of the dialogue generation server 100 according to one embodiment of the present disclosure. The dialogue generation server 100 described above may be physically configured as a computer device that includes a processor 1001, a memory 1002, a storage 1003, a communication device 1004, an input device 1005, an output device 1006, a bus 1007 and the like.

In the following description, the term “device” may be replaced with a circuit, a device, a unit, or the like. The hardware configuration of the dialogue generation server 100 may be configured to include one or a plurality of the devices shown in the drawings or may be configured without including some of those devices.

The functions of the dialogue generation server 100 may be implemented by loading predetermined software (programs) on hardware such as the processor 1001 and the memory 1002, so that the processor 1001 performs computations to control communications by the communication device 1004 and control at least one of reading and writing of data in the memory 1002 and the storage 1003.

The processor 1001 may, for example, operate an operating system to control the entire computer. The processor 1001 may be configured to include a CPU (Central Processing Unit) including an interface with a peripheral device, a control device, an arithmetic device, a register and the like. For example, the action decision unit 102, the character control unit 103 and the like described above may be implemented by the processor 1001.

Further, the processor 1001 loads a program (program code), a software module and data from at least one of the storage 1003 and the communication device 1004 into the memory 1002 and performs various processing according to them. As the program, a program that causes a computer to execute at least some of the operations described in the above embodiments is used. For example, the action decision unit 102, the character control unit 103 may be implemented by a control program that is stored in the memory 1002 and operates on the processor 1001, and the other functional blocks may be implemented in the same way. Although the above-described processing is executed by one processor 1001 in the above description, the processing may be executed simultaneously or sequentially by two or more processors 1001. The processor 1001 may be implemented in one or more chips. Note that the program may be transmitted from a network through a telecommunications line.

The memory 1002 is a computer-readable recording medium, and it may be composed of at least one of ROM (Read Only Memory), EPROM (ErasableProgrammable ROM), EEPROM (Electrically ErasableProgrammable ROM), RAM (Random Access Memory) and the like, for example. The memory 1002 may be also called a register, a cache, a main memory (main storage device) or the like. The memory 1002 can store a program (program code), a software module and the like that can be executed for implementing the dialogue generation method according to one embodiment of the present disclosure.

The storage 1003 is a computer-readable recording medium, and it may be composed of at least one of an optical disk such as a CD-ROM (Compact Disk ROM), a hard disk drive, a flexible disk, a magneto-optical disk (e.g., a compact disk, a digital versatile disk, and a Blu-ray (registered trademark) disk), a smart card, a flash memory (e.g., a card, a stick, and a key drive), a floppy (registered trademark) disk, a magnetic strip and the like, for example. The storage 1003 may be called an auxiliary storage device. The above-described storage medium may be a database, a server, or another appropriate medium including at least one of the memory 1002 and/or the storage 1003, for example.

The communication device 1004 is hardware (a transmitting and receiving device) for performing communication between computers via at least one of a wired network and a wireless network, and it may also be referred to as a network device, a network controller, a network card, a communication module, or the like. The communication device 1004 may include a high-frequency switch, a duplexer, a filter, a frequency synthesizer or the like in order to implement at least one of FDD (Frequency Division Duplex) and TDD (Time Division Duplex), for example. For example, the above-described communication unit 101, the virtual space provision unit 104 may be implemented by the communication device 1004. The communication device 1004 may be implemented in such a way that a transmitting unit and a receiving unit are physically or logically separated.

The input device 1005 is an input device (e.g., a keyboard, a mouse, a microphone, a switch, a button, a sensor, etc.) that receives an input from the outside. The output device 1006 is an output device (e.g., a display, a speaker, an LED lamp, etc.) that makes output to the outside. Note that the input device 1005 and the output device 1006 may be integrated (e.g., a touch panel).

In addition, the devices such as the processor 1001 and the memory 1002 are connected by the bus 1007 for communicating information. The bus 1007 may be a single bus or may be composed of different buses between different devices.

Further, the dialogue generation server 100 may include hardware such as a microprocessor, a DSP (Digital Signal Processor), an ASIC (Application Specific Integrated Circuit), a PLD (Programmable Logic Device), and an FPGA (Field Programmable Gate Array), and some or all of the functional blocks may be implemented by the above-described hardware components. For example, the processor 1001 may be implemented with at least one of these hardware components.

Notification of information may be made by another method, not limited to the aspects/embodiments described in the present disclosure. For example, notification of information may be made by physical layer signaling (e.g., DCI (Downlink Control Information), UCI (Uplink Control Information)), upper layer signaling (e.g., RRC (Radio Resource Control) signaling, MAC (Medium Access Control) signaling, annunciation information (MIB (Master Information Block), SIB (System Information Block))), another signal, or a combination of them. Further, RRC signaling may be called an RRC message, and it may be an RRC Connection Setup message, an RRC Connection Reconfiguration message or the like, for example.

The procedure, the sequence, the flowchart and the like in each of the aspects/embodiments described in the present disclosure may be in a different order unless inconsistency arises. For example, for the method described in the present disclosure, elements of various steps are described in an exemplified order, and it is not limited to the specific order described above.

Input/output information or the like may be stored in a specific location (e.g., memory) or managed in a management table. Further, input/output information or the like can be overwritten or updated, or additional data can be written. Output information or the like may be deleted. Input information or the like may be transmitted to another device.

The determination may be made by a value represented by one bit (0 or 1), by a truth-value (Boolean: true or false), or by numerical comparison (e.g., comparison with a specified value).

Each of the aspects/embodiments described in the present disclosure may be used alone, may be used in combination, or may be used by being switched according to the execution. Further, a notification of specified information (e.g., a notification of “being X”) is not limited to be made explicitly, and it may be made implicitly (e.g., a notification of the specified information is not made).

Although the present disclosure is described in detail above, it is apparent to those skilled in the art that the present disclosure is not restricted to the embodiments described in this disclosure. The present disclosure can be implemented as a modified and changed form without deviating from the spirit and scope of the present disclosure defined by the appended claims. Accordingly, the description of the present disclosure is given merely by way of illustration and does not have any restrictive meaning to the present disclosure.

Software may be called any of software, firmware, middleware, microcode, hardware description language or another name, and it should be interpreted widely so as to mean an instruction, an instruction set, a code, a code segment, a program code, a program, a sub-program, a software module, an application, a software application, a software package, a routine, a sub-routine, an object, an executable file, a thread of execution, a procedure, a function and the like.

Further, software, instructions and the like may be transmitted and received via a transmission medium. For example, when software is transmitted from a website, a server or another remote source using at least one of wired technology (a coaxial cable, an optical fiber cable, a twisted pair and a digital subscriber line (DSL) etc.) and wireless technology (infrared rays, microwave etc.), at least one of those wired technology and wireless technology are included in the definition of the transmission medium.

The information, signals and the like described in the present disclosure may be represented by any of various different technologies. For example, data, an instruction, a command, information, a signal, a bit, a symbol, a chip and the like that can be referred to in the above description may be represented by a voltage, a current, an electromagnetic wave, a magnetic field or a magnetic particle, an optical field or a photon, or an arbitrary combination of them.

Note that the term described in the present disclosure and the term needed to understand the present disclosure may be replaced by a term having the same or similar meaning.

Further, information, parameters and the like described in the present disclosure may be represented by an absolute value, a relative value to a specified value, or corresponding different information. For example, radio resources may be indicated by an index.

The names used for the above-described parameters are not definitive in any way.

In the present disclosure, the terms such as “Mobile Station (MS)” “user terminal”, “User Equipment (UE)” and “terminal” can be used to be compatible with each other.

The mobile station can be also called, by those skilled in the art, a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client or several other appropriate terms.

Note that the term “determining” and “determining” used in the present disclosure includes a variety of operations. For example, “determining” and “determining” can include regarding the act of judging, calculating, computing, processing, deriving, investigating, looking up/searching/inquiring (e.g., looking up in a table, a database or another data structure), ascertaining or the like as being “determined” and “determined”. Further, “determining” and “determining” can include regarding the act of receiving (e.g., receiving information), transmitting (e.g., transmitting information), inputting, outputting, accessing (e.g., accessing data in a memory) or the like as being “determined” and “determined”. Further, “determining” and “determining” can include regarding the act of resolving, selecting, choosing, establishing. comparing or the like as being “determined” and “determined”. In other words, “determining” and “determining” can include regarding a certain operation as being “determined” and “determined”. Further, “determining (determining)” may be replaced with “assuming”, “expecting”, “considering” and the like.

The term “connected”, “coupled” or every transformation of this term means every direct or indirect connection or coupling between two or more elements, and it includes the case where there are one or more intermediate elements between two elements that are “connected” or “coupled” to each other. The coupling or connection between elements may be physical, logical, or a combination of them. For example, “connect” may be replaced with “access”. When used in the present disclosure, it is considered that two elements are “connected” or “coupled” to each other by using at least one of one or more electric wires, cables, and printed electric connections and, as several non-definitive and non-comprehensive examples, by using electromagnetic energy such as electromagnetic energy having a wavelength of a radio frequency region, a microwave region and an optical (both visible and invisible) region.

The description “on the basis of” used in the present disclosure does not mean “only on the basis of” unless otherwise noted. In other words, the description “on the basis of” means both of “only on the basis of” and “at least on the basis of”.

When the terms such as “first” and “second” are used in the present disclosure, any reference to the element does not limit the amount or order of the elements in general. Those terms can be used in the present disclosure as a convenient way to distinguish between two or more elements. Thus, reference to the first and second elements does not mean that only two elements can be adopted or the first element needs to precede the second element in a certain form.

As long as “include”, “including” and transformation of them are used in the present disclosure, those terms are intended to be comprehensive like the term “comprising”. Further, the term “or” used in the present disclosure is intended not to be exclusive OR.

In the present disclosure, when articles, such as “a”, “an”, and “the” in English, for example, are added by translation, the present disclosure may include that nouns following such articles are plural.

In the present disclosure, the term “A and B are different” may mean that “A and B are different from each other”. Note that this term may mean that “A and B are different from C”. The terms such as “separated” and “coupled” may be also interpreted in the same manner.

### REFERENCE SIGNS LIST

101 Communication unit, 102 Action decision unit, 103 Character control unit, 104 Virtual space provision unit, 100a User information DB, 100b Virtual space information DB, 201 Communication unit, 202 Display unit, 203 Microphone, 204 Operation unit, 205 Speaker

1. A character control device comprising:
an action decision unit configured to decide an action of a computer character on the basis of user information about a user and a response estimation time required for a response of a predetermined action for the computer character if the predetermined action is received from a user character operated by the user in a virtual space; and
a character control unit configured to present the decided action of the computer character to the user.

2. The character control device according to claim 1, wherein the user information is information about the user's acceptance level for a response estimation time of the computer character.

3. The character control device according to claim 1, wherein the user information is information about locations of the user character and the computer character in the virtual space,

4. The character control device according to claim 3, wherein the information about the locations indicates a specific area in the virtual space where the user character and the computer character are located.

5. The character control device according to claim 1, wherein the user information is information about a time period of day during which the action has been received from the user character.

6. The character control device according to claim 5, wherein the time period of day is related to a state of the specific area in the virtual space where the user character is located.

7. The character control device according to claim 1, wherein the user information is information about a display aspect of the user character.

8. The character control device according to claim 1, wherein the user information is an operation state of the user character by the user.

9. A terminal device comprising:
a display unit configured to display a virtual space including a user character that is operated by a user and a computer character that is controlled by a computer,
wherein the display unit performs a display process according to an action of the computer character decided on the basis of user information about the user and a response estimation time required for a response of a predetermined action for the computer character if the predetermined action is performed from the user character in the virtual space.

10. A virtual space providing system that includes a terminal device that is operated by a user and a server device that provides a virtual space to the terminal device,
wherein the server device includes:
an action decision unit configured to decide an action of a computer character on the basis of user information about a user and a response estimation time required for a response of a predetermined action for the computer character if the predetermined action is received from a user character operated by the user in the virtual space; and
a character control unit configured to cause the decided action of the computer character to be displayed on a user terminal, and
wherein the terminal device includes
a display unit configured to display the virtual space including the user character that is operated by the user and the computer character that is controlled by a computer.
